(19) United States
(12) Patent Application Publication
(10) Pub. No.: US 2009/0188149 A1
(43) Pub. Date: Jul. 30, 2009

(54) Fishing Rod

(76) Inventor: Robert D. Smith, Glen Rock, NJ (US)

Correspondence Address: WEITZMAN LAW OFFICES, LLC, 425 EAGLE ROCK AVENUE, SUITE 102, ROSELAND, NJ, 07068, US

(21) Appl. No.: 12/020,080

(22) Filed: Jan. 25, 2008

(51) Int. Cl. A01K 87/00

(52) U.S. Cl. 43/18.1 R

(57) ABSTRACT

An improved fishing rod comprising a plurality of generally triangular shaped strips joined together to define an elongated body having a distal end, a proximal end, and a plurality of sides extending from the distal end to the proximal end. Each of the triangular strips has an exterior side that defines a side of the rod and two interior sides that define an angle opposite the exterior side. The angle opposite the exterior side of at least one of the triangular strips is greater than the angle opposite the exterior side of the remaining triangular strips.

### FIELD

This application relates generally to fishing rods, and more particularly, to an improved fly fishing rod constructed from multiple strips of rod material.

### BACKGROUND

Fly fishing is an ancient angling method in which fish are caught using an artificial fly or lure cast with a fly fishing rod and a fly line. Fly fishing rods are typically thin, flexible fishing rods designed to cast the artificial fly. Fly fishing rods normally vary between six feet and 13 feet in length and are designated by weight (e.g., 0 wt. through 16 wt.).

Fly fishing rods vary in action from slow to fast depending on the taper of the rod from one end (the “butt”) to the other end (the “tip”). In addition, fly fishing rods have different characteristics depending on the cross-sectional configuration of the rod. For example, some existing fly fishing rods have a cross-section that is shaped as a square (“quad”), pentagon (“penta”) or hexagon (“hex”).

Despite the emergence of fishing rods made from composite materials, such as fiberglass or carbon graphite, fly fishing rods made from naturally occurring materials, such a split-cane bamboo, remain in demand. Bamboo fly fishing rods offer grace, form and surprising strength. Many bamboo fly fishing rods are handmade by experienced craftsman. To make a quality fly fishing rod, it can take an experienced rod builder in excess of 100 hours to select and split the raw bamboo into smaller strips and cure, flame, plane, file, taper, glue, wrap and finish the rod.

Some existing bamboo fly fishing rods are solid and others are constructed from identically shaped triangular strips of bamboo that are glued or otherwise bonded together to form the desired cross-sectional configuration (e.g., quad, penta, hex, etc.). One example is a “quad” fly fishing rod that is constructed from four glued bamboo strips, each having an identical cross-section consisting of an equilateral triangle. When the four, identical triangular strips are glued together, they form a “quad” cross-section consisting of four equal sides.

Because the cross-sectional configuration of the rod can affect the characteristics of the fly fishing rod, there are often tradeoffs that must be made in selecting one cross-section over another. For instance, although existing “penta” fly fishing rods tend to be excellent for casting, catching fish using these existing rods can be challenging because the line is difficult to balance. Similarly, existing “quad” fly fishing rods tend to have power, but are heavy, do not respond quickly, and can be difficult to manipulate. Thus, it is desirable to have an improved fly fishing rod that is light, powerful and easy to control.

### SUMMARY

A fishing rod is disclosed herein that overcomes many of the shortcomings of existing fly fishing rods. The fishing rod comprises a plurality of generally triangular shaped strips joined together to define an elongated body having a distal end, a proximal end, and a plurality of sides extending from the distal end to the proximal end. Each of the triangular strips has an exterior side that defines a side of the rod and two interior sides that define an angle opposite the exterior side. The angle opposite the exterior side of at least one of the triangular strips is greater than the angle opposite the exterior side of the remaining triangular strips.

In another embodiment, the fishing rod comprises an elongated body having a distal end, a proximal end, and a plurality of exterior sides extending from the distal end to the proximal end. Each exterior side has a measurable exterior side width at a given point along the rod between the distal and proximal ends. The measurable exterior side width of at least one of the exterior sides is less than the measurable exterior side width of another exterior side at each particular point along the rod between the distal and proximal ends.

These and other advantages of the present disclosure will be apparent to those of ordinary skill in the art by reference to the following detailed description and the accompanying drawings.

### BRIEF DESCRIPTION OF THE DRAWINGS

FIG. 1 is a perspective view of an exemplary section of a preferred multi-stripped fishing rod;

FIG. 2 is a cross-sectional diagram of the multi-striped fishing rod illustrated in FIG. 1; and

FIG. 3 is a cross-sectional diagram of an exemplary strip of rod material used in the construction of the fishing rod illustrated in FIG. 1.

### DETAILED DESCRIPTION

An improved fishing rod is disclosed herein having surprisingly good power, casting action and accuracy, but with a smaller cross-section as compared to existing fly fishing rods having similar characteristics.

The fishing rod disclosed herein is preferably made from multiple strips of rod material, preferably split cane bamboo such as Tonkin cane. It is understood, however, that the rod can be made from other known materials suitable for use as a fishing rod and that this disclosure is not intended to be limited to bamboo fishing rods. It is also understood that the fishing rod disclosed herein can be made from a solid piece of rod material and is not limited to being made from multiple strips of rod material.

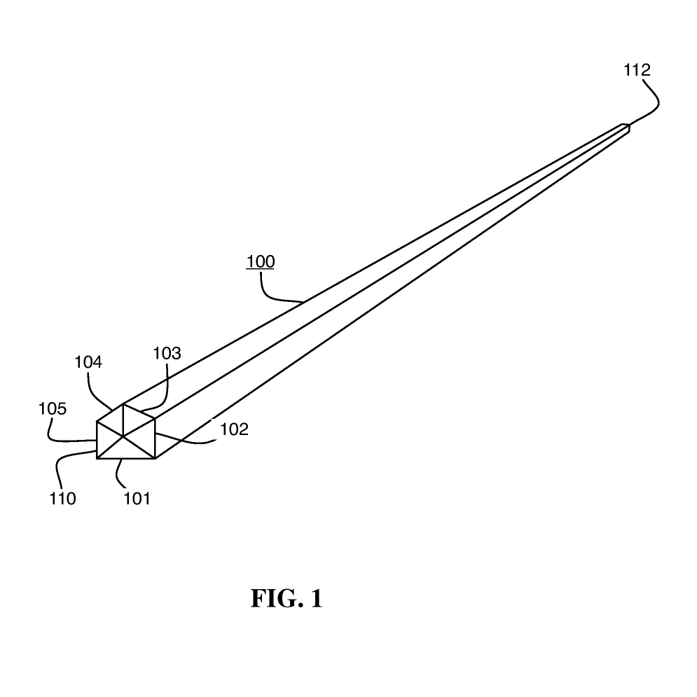

FIG. 1 illustrates an exemplary section of a preferred fishing rod 100 that can be used, for example, for fly fishing. The rod 100 is preferably a “penta” fishing rod having a five-sided or pentagon-shaped cross-section formed by assembling five triangular strips 101, 102, 103, 104, 105 of rod material together. The rod 100 is preferably tapered from about one end 110 to about the other end 112. The amount of taper along the length of the rod 100 is discussed further below. It is understood that the fishing rod 100 may be formed from a single section (as shown in FIG. 1) or multiple sections that can be interconnected in a conventional manner as an assembled fishing rod.

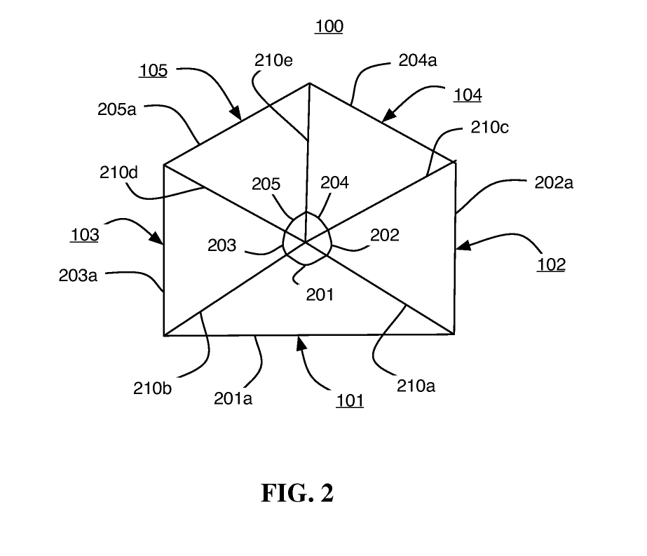

FIG. 2 is a cross-sectional view of the rod 100 showing the five generally triangular strips 101, 102, 103, 104, 105 assembled together. Preferably, two of the sides on each of the five triangular strips are of equal length so that the cross-section of each strip of rod material defines an isosceles triangle. For instance, triangular strip 101 is defined by three sides 201a, 210a and 210b, with two of the sides 210a, 210b preferably being of equal length. Triangular strip 102 is defined by three sides 202a, 210a and 210c, with two of the sides 210a, 210c preferably being of equal length. Triangular strip 103 is defined by three sides 203a, 210b and 210d, with two of the sides 210b, 210d preferably being of equal length. Triangular strip 104 is defined by three sides 204a, 210c and 210e, with two of the sides 210c, 210e preferably being of equal length. Lastly, triangular strip 105 is defined by three sides 205a, 210d and 210e, with two of the sides 210d, 210e preferably being of equal length.

The first strip 101 (also referred to herein as the “quad” strip) is a triangular strip of rod material having a preferred angle 201 of approximately 92°. The two other angles in the isosceles triangle of the first strip 101 are each approximately 44°. It is preferred that the first strip 101 defines the primary casting plane (i.e., the plane on which the guides are mounted) since it is the most stable of the planes formed by the triangular strips.

The second and third strips 102, 103 (also referred to herein as the “penta” strips) are each a triangular strip of rod material having a preferred angle 202, 203 of approximately 73.5°. The two other angles in each of the isosceles triangles of the second and third strips 102, 103 are each approximately 53.25°. The second and third strips 102, 103 help to stabilize the primary casting plane defined by the first strip 101. They can have non-squared opposite flats and, by volume, tend to be the stiffest of the strips 101, 102, 103, 104, 105 when glued together and the rod 100 is flexed.

The fourth and fifth strips 104, 105 (also referred to herein as the “hex” strips) are each a triangular strip of rod material having a preferred angle 204, 205 of approximately 60.5°. The two other angles in each of the isosceles triangles of the fourth and fifth strips 104, 105 are each approximately 59.75°. Alternatively, angle 204, 205 could be approximately 61.5°, with a corresponding change in the two other angles in each of the isosceles triangles of the fourth and fifth strips 104, 105.

It is understood that the disclosed fishing rod is not intended to be limited to the preferred angles recited herein and that different angles may utilized without departing from the spirit and scope of this disclosure.

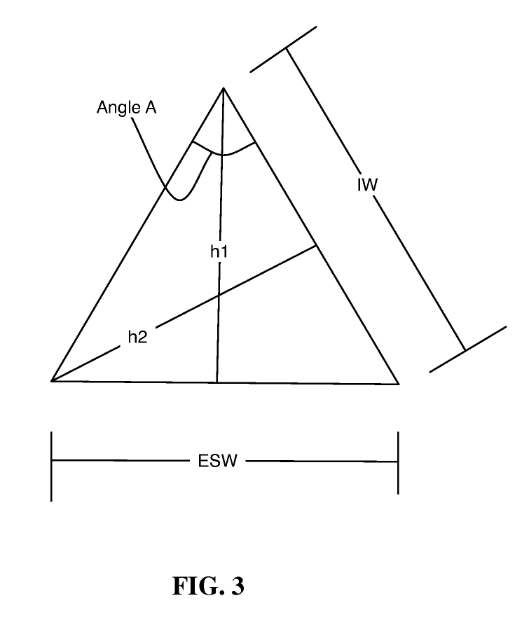

In the preferred embodiment, the two equal sides (i.e., sides 210a, 210b, 210c, 210d and 210e) in all of the triangular strips have the same length. As shown in FIG. 3, this length is referred to as the “inside width” IW and is preferably the same for all strips 101, 102, 103, 104, 105 at any given point along the length of the rod 100. In this manner, when the strips are assembled together as illustrated in FIGS. 1 and 2, the apex or point where each of the triangular strip 101, 102, 103, 104, 105 meet is preferably off-center (e.g., centered left to right, but lower top to bottom) because the dimension IW for each strip is the same at that particular point.

In contrast, the length of the unequal side (i.e., side 201a, 202a, 203a, 204a, 205a) in each of the triangular strips 101, 102, 103, 104, 105 is referred to as the “exterior enamel side” or “exterior side width” ESW. In the preferred embodiment, this dimension will vary between the first strip 101, second and third strips 102, 103, and third and fourth strips 104, 105 at any given point along the length of the rod 100.

The disclosed rod 100 may be made using standard rod maker tools, such as block planes, a scraper plane, splicing blocks, dial calipers, a dial indicator depth gauge, planing forms, and/or a hand mill such as, for example, a Morgan Bamboo Hand Mill. Once the rod material (e.g., bamboo) is selected, it is split into narrow strips and any protrusions caused by nodes in the rod material are removed using a plane and file. Heat and pressure can also be used to remove such imperfections. One or more planing forms can then be used to plane each strip 101, 102, 103, 104, 105 to the desired angles.

Preferably, the quad strip 101 is planed first, then the penta strips 102, 103 are planed second, and the hex strips 104, 105 are planed last. If the hex strips 104, 105 are planed first, one may be required to use a new anvil and thus reset the taper for the other strips as there may not be enough support for the edges of the wider strips. Cutting from widest to narrowest should allow for only one setting for all of the strips as their relative rate of change along the entire strip will be identical. This can be important since thinner than normal strips may ultimately be cut. It is also preferred that the strips have very consistent edges given the various and unusual angles around the rod 100. As such, the quality of the rod material (e.g., bamboo) can also be important.

Once each strip 101, 102, 103, 104, 105 is planed to the desired triangular configuration, the triangular strips can be assembled together in the penta configuration shown in FIGS. 1 and 2. The assembled strips are then bound together with string and placed in a heat treating oven to dry, straighten and temper the strips. Thereafter, each of the strips 101, 102, 103, 104, 105 is preferably tapered from about one end 110 to about the other end 112 using, for example, a set of adjustable planing forms. The amount of the taper is discussed further below.

The tapered strips 101, 102, 103, 104, 105 are reassembled into, for example, the configuration illustrated in FIGS. 1 and 2, and the strips are glued or otherwise bonded together using, for example, Acraglas Gel® manufactured by Brownells, Inc. Preferably, the strips are glued together with a small amount space between the apex or tip of the triangular sections.

The glued strips 101, 102, 103, 104, 105 are then preferably tightly bound together with cotton thread using, for example, a Garrison-style rod binding machine. This process can also be done by hand. The glued, tapered strips 101, 102, 103, 104, 105 forming the rod 100 may then be sanded to remove any excess glue. The rod 100 can be finished with a cork grip and reel seat, and then a final varnish may be applied to the rod.

FIG. 3 illustrates the cross-section of a single strip of rod material used to make the disclosed fishing rod 100. The inside width IW refers to the length of the two equal sides that form the vertex defined by angle A. Angle A corresponds to angles 201, 202, 203, 204, 205 illustrated in FIG. 2. Similarly, the Enamel Side Width ESW refers to the length of the unequal or exterior side (i.e., sides 201a, 202a, 203a, 204a, 205a) of each of the isosceles triangles defined by strips 101, 102, 103, 104, 105. The enamel apex height h1 is the height of the apex (defined by the point where the two equal sides of a triangular strip meet) as measured from the unequal or exterior side of the triangular strip. The inside apex height h2 is the height of the apex (defined by the point where one of the equal sides meets with the unequal or exterior side of a triangular strip) as measured from the opposing equal side of the triangular strip. As discussed above, all of the triangular strips 101, 102, 103, 104, 105 preferably have identical inside widths

As mentioned above, the rod 100 is preferably tapered from one end (the “butt”) 110 to the other end (the “tip”) 112. The following chart illustrates the preferred rates of change of inside width IW and exterior side width ESW at five-inch intervals along the length of an exemplary 7.5 foot long 4 wt. rod 100 from the tip 112 to the butt 110.

| INCHES | RATE OF |
|---|---|
| (FROM TIP) | CHANGE |
| 0 | 0.064 |
| 5 | 0.06 |
| 10 | 0.0505 |
| 15 | 0.0435 |
| 20 | 0.0365 |
| 25 | 0.0325 |
| 30 | 0.028 |
| 35 | 0.022 |
| 40 | 0.014 |
| 45 | 0.004 |
| 50 | 0.05 |
| 55 | 0.04 |
| 60 | 0.0335 |
| 65 | 0.026 |
| 70 | 0.0165 |
| 75 | 0.007 |
| 80 | 0 |
| 85 | 0 |
| 90 | 0 |

It is preferred that the height measurements for each triangular section are obtained using a V-block. Another approach is to measure the exterior enamel side or exterior side width ESW for each triangular strip 101, 102, 103, 104, 105 at the same point along the taper using, for example, a standard micrometer.

In the preferred embodiment, the inside widths IW of all strips are equal at any given point across the length of the rod, while the ESW measurements vary between the quad strip 101, the penta strips 102, 103, and the hex strips 104, 105. For example, the preferred ESW measurement at the mid-point along the 7.5 foot length of a preferred 4 wt. rod 100 is 0.108 inches for the hex strips 104, 105, 0.128 inches for the penta strips 102, 103, and 0.155 inches for the quad strip 101. Similarly, the preferred IW measurement for all of the strips at the mid-point along the length of this exemplary 7.5 foot rod is 0.107 inches. Using these measurements and the rate of change table above, the preferred ESW and IW measurements can then be calculated for each point along the length of the rod 100.

Alternatively, the following mathematical equations may be utilized to calculate ESW, IW, h1 and h2 for each triangular strip at particular point along the length of the rod 100:

ESW (Enamel Side Width)=2×h1×tan (A/2)

IW (Inside Width)=h1/cos (A/2)

h1 (Enamel apex height)=½×ESW/tan (A/2)

h2 (Inside apex height)=ESW×cos (A/2)

where A=92° for the quad strip 101; 73.5° for the penta strips 102, 103; and 60.5° for the hex strips 104, 105. Using these numbers and the rate of change chart above, a rod builder can calculate the target width ESW and height h1 for each strip 101, 102, 103, 104, 105 at points along the length of the rod 100.

Conversion factors may also be used to measure the width of the strips at various points along its length. Preferred conversion factors include:

For the hex strips 104, 105: W=2×tan (60.5/2)=2×tan (30.25)=1.166:

For the quad strip 101: W=2×tan (92/2)=2×tan (46)=2.071: and

For the penta strips 102, 103: W=2×tan (73.5/2)=2×tan (36.75)=1.494.

Furthermore, the conversion factors from the multiplier 1/(sine of the outer angle) for the other angles are:

For the preferred quad strip 101 having a 44° angle, the multiplier is 1.44;

For the preferred penta strips 102, 103 having a 53.25° angle, the multiplier is 1.25; and

For the preferred hex strips 104, 105 having a 59.75°, the multiplier is about 1.16.

Having described and illustrated the principles of this application by reference to one or more preferred embodiments, it should be apparent that the preferred embodiment(s) may be modified in arrangement and detail without departing from the principles disclosed herein and that it is intended that the application be construed as including all such modifications and variations insofar as they come within the spirit and scope of the subject matter disclosed herein.

What is claimed is:

1. A fishing rod, comprising:
a plurality of generally triangular shaped strips joined together to define an elongated body having a distal end, a proximal end, and a plurality of sides extending from the distal end to the proximal end;
each of the triangular strips including an exterior side that defines a side of the rod and two interior sides that define an angle opposite the exterior side;
wherein the angle opposite the exterior side of at least one of the triangular strips is greater than the angle opposite the exterior side of the remaining triangular strips.

2. The fishing rod according to claim 1, wherein each of the generally triangular strips define an isosceles triangle whose interior sides have the same length.

3. The fishing rod according to claim 2, wherein the interior sides of each of the triangular strips are the same length at any given point along the rod from the distal end to the proximal end.

4. The fishing rod according to claim 3, wherein the rod has a first generally triangular shaped strip, a second generally triangular shaped strip, a third generally triangular shaped strip, a fourth generally triangular shaped strip and a fifth generally triangular shaped strip joined together to define the elongated body whose cross-section is in the shape of a pentagon having at least one unequal side.

5. The fishing rod according to claim 4, wherein the angle opposite the first side in the first triangular strip is greater than the angle opposite the exterior side of the second, third, fourth and fifth triangular strips.

6. The fishing rod according to claim 5, wherein the angle opposite the exterior side of the first triangular strip is approximately 92°.

7. The fishing rod according to claim 5, wherein the angle opposite the exterior side of the second and third triangular strips are the same.

8. The fishing rod according to claim 7, wherein the angle opposite the exterior side of the second and third triangular strips is approximately 73.5°.

9. The fishing rod according to claim 7, wherein the angle opposite the exterior side of the second and third triangular strips is greater than the angle opposite the exterior side of the fourth and fifth triangular strips.

10. The fishing rod according to claim 9, wherein the angle opposite the exterior side of the fourth and fifth triangular strips are the same.

11. The fishing rod according to claim 10, wherein the angle opposite the exterior side of the fourth and fifth triangular strips is approximately 60.5°.

12. The fishing rod according to claim 1, wherein the width of the interior sides and the width of the exterior side of each triangular strip decrease at a predetermined rate of change along each strip.

13. The fishing rod according to claim 1, wherein the triangular strips are made from bamboo.

14. A fishing rod, comprising:
an elongated body having a distal end, a proximal end, and a plurality of exterior sides extending from the distal end to the proximal end, each exterior side having a measurable exterior side width at a given point along the rod between the distal and proximal ends;
wherein the measurable exterior side width of at least one of the exterior sides is less than the measurable exterior side width of another exterior side at each particular point along the rod between the distal and proximal ends.

15. The fishing rod according to claim 14, wherein the rod includes a first exterior side, a second exterior side, a third exterior side, a fourth exterior side, and a fifth exterior side, and the cross-section of the rod is in the form of a pentagon having at least one unequal side.

16. The fishing rod according to claim 15, wherein the measurable exterior side width of the first exterior side is greater than the measurable exterior side width of the second, third, fourth and fifth exterior sides at each particular point along the rod between the distal and proximal ends.

17. The fishing rod according to claim 16, wherein the measurable exterior side width of the second and third exterior sides is the same at each particular point along the rod between the distal and proximal ends.

18. The fishing rod according to claim 17, wherein the measurable exterior side width of the second and third exterior sides are greater than the measurable exterior side width of the fourth and fifth exterior sides at each particular point along the rod between the distal and proximal ends.

19. The fishing rod according to claim 18, wherein the measurable exterior side width of the fourth and fifth exterior sides is the same at each particular point along the rod between the distal and proximal ends.

20. The fishing rod according to claim 14, wherein the rod is tapered from about the proximal end to about the distal end.

21. The fishing rod according to claim 14, wherein the rod is made from bamboo.
